(19) United States
(12) Patent Application Publication
(10) Pub. No.: US 2018/0371631 A1
(43) Pub. Date: Dec. 27, 2018

(54) EXPOSED SEGMENTED NANOSTRUCTURE ARRAYS

(71) Applicant: University of Houston System, Houston, TX (US)

(72) Inventors: Li Sun, Houston, TX (US); Christopher M. Ortega, Houston, TX (US)

(73) Assignee: University of Houston System, Houston, TX (US)

(21) Appl. No.: 15/776,690

(22) PCT Filed: Nov. 18, 2016
(86) PCT No.: PCT/US2016/062720

§ 371 Date: May 16, 2018

Related U.S. Application Data
(60) Provisional application No. 62/256,888, filed on Nov. 18, 2015.

(51) Int. Cl. C25D 1/00; B82B 3/00

(52) U.S. Cl. CPC C25D 1/006; B82B 3/0014

(57) ABSTRACT

A template assisted electrochemical synthesis (TAES) technique is utilized to produce an exposed segmented nanostructure array (ESNA). The ESNA may provide a conductive substrate, insulating layer, and an array of segmented nanostructures. The insulating layer may separate the conductive substrate from the exposed portions of the segmented nanostructures, but another portion of the segmented nanostructures may be embedded in the insulating layer. This embedded portion of the segmented nanostructure may contact the conductive substrate. The ESNA may be produced by electrochemical deposition process(es) utilizing a multi-layered membrane with a conductive substrate as a template, where the multi-layered membrane has layers with pores corresponding to the dimensions of the desired segments of the segmented nanostructure. When a desired shape is desired on the tip of the nanostructure, deposition may continue for a predetermined time after the pore is filled. After the deposition of material(s) in the pores of the multi-layered membrane, one or more layers of the multi-layered membranes may be dissolved to exposed a portion of the segmented nanostructures, but another portion of the segmented nanostructures remains embedded in the undissolved portion of the multi-layer membrane. When capped or core-shell ESNAs are desired, the deposition may be separated into multiple steps to achieve the desired segmented nanostructure.

### RELATED APPLICATIONS

This application claims the benefit of U.S. Provisional Patent Application No. 62/256,888 filed on Nov. 18, 2015, which is incorporated herein by reference.

### FIELD OF THE INVENTION

This invention relates to exposed segmented nanostructure arrays and corresponding methods of fabrication.

### BACKGROUND OF INVENTION

One of the main challenges of one-dimensional nanomaterial applications is the high cost and low productivity/repeatability of producing a large quantity of free-standing high-aspect ratio nanostructures with user-defined: geometry, composition, and density. Traditional lithography based technologies are incapable and/or ineffective for fabricating aligned high-aspect ratio dense nanostructure arrays, and changes in nanostructure normally requires retooling. Another issue with current nano-manufacturing techniques is that modulation of properties along the nanomaterials is difficult to achieve. Once the nanomaterials are made, further modification of the structures and integration of the nanomaterials in devices are also difficult.

There is high interest in nanostructure arrays in several technological fields, due to dimensional, surface and/or structure induced effects. An example of this enhancement can be demonstrated by comparing a nanostructure array to a planar film for their applications as a sensor. Nano-array will have a greatly increased surface area compared to that of a planar film for a given sensor area. This increase in surface area will be proportional to any surface-limited reaction signal, thus allowing for higher signal strength with nanostructured arrays. These affects are already documented for micro-arrays, but to further increase the enhancements, the dimensions must now be reduced to the nano-scale range (e.g. ˜1-100 nm).

Theoretical and lab-scale experiments involving nano-arrays have demonstrated enhancements in sensors, electronics, and optics on orders of magnitude compared to bulk materials. This potential has drawn interest in nano-arrays for commercial applications, but implementation has been limited due to the high-cost and low-throughput in manufacturing nano-arrays. Furthermore, for industrial applications, nano-array manufacturing processes need to maintain adequate control and uniformity of the nanostructures, and be suitable for batch or continuous production. A large volume of research over the last 10 years has focused on new methods of creating arrays of nanostructures or modifying existing methods, such as to improve control over fabrication, reduce costs, or increase throughput. For a new method of manufacturing nanostructure arrays to be viable for industrial applications it must: be cost-effective, allow for continuous or batch production, have high uniformity among nanostructures in arrays, have high repeatability between arrays, have dimensions and composition that can be tailored by user, and require no highly-toxic chemicals or processes.

Nanostructure arrays are currently produced using either one or a combination of top-down or bottom-up approaches. Top-down approaches require “etching” away a large bulk material to form nano-features, while bottom-up approaches require “growing” a material from atomic or molecular level to achieve nano-features. Most modern forms of nanofabrication though use a combination of these two approaches, such as in Template Assisted Electrochemical Synthesis (TAES). TAES requires the formation of a nano-porous membrane through a top-down approach, followed by the deposition of material into the pores using electrochemical reaction (bottom-up). This results in an array of nanostructures that take up the shape/dimensions of the pores in the membrane, which acts as a template during deposition. The membrane/template can be dissolved away post-deposition to fully expose the nanostructures if desired. Although the electrochemical deposition process controls the type of species deposited and the nanostructures composition, it is the template that determines the nanostructures: geometry, orientation, and nanostructure density. It is therefore the method of forming the template that is the critical process in developing arrays of nanostructures.

Templates may be composed of an insulating nano-porous membrane that is affixed to a substrate which acts as an electrode where electrochemical reactions occur during the deposition process. Common types of templates for TAES are: lithographic patterned films, anodized aluminum oxide (AAO), diblock copolymer, and nuclear track membranes. Lithography has proven to be a highly versatile tool for fabricating porous films with a wide range of pore geometry. The pores can also be periodically arranged, and using e-beam lithography techniques, can have dimensions ranging down to ˜5 nm. Drawbacks of lithography are that the equipment to produce nanostructures requires ultra-high vacuum systems, which reduce the processing throughput, and equipment, such as e-beam writers, are very expensive. Although UV lithography is cheaper and has a much higher throughput, it is not reliable for producing nanostructures with features less than ˜200 nm with high aspect-ratios. AAO membranes are produced easily and cheaply through an anodization process of aluminum films, which results in pores arranged in a quasi-hexagonal pattern. But the pore density and size cannot be independently controlled in AAO membranes, and formed nanopores have wide range of size distribution and rough pore walls.

The nuclear track process has proven to be a reliable method of forming porous films for use as either membrane technology or as a template for nanofabrication of nanostructure arrays. The nuclear track process is a two-step process of forming pores in a dielectric material, such as inorganic crystals, glass, or polymers. The process involves the bombardment of the dielectric material with high-energy heavy particles (e.g. >1 MeV/u) to create damaged zones corresponding to material ionization. These ionized damaged zones, referred to as nuclear tracks, and are then etched with a weak chemical etchant that attacks the nuclear tracks at a much higher etching rate than the bulk material. Full through pores in polymer and inorganic single-crystal films can be formed with this process through an appropriate choice of bombarding particle, particle energy and etchant. FIGS. 1A-1B respectively show nuclear track pores formed in a polycarbonate film and in a single-crystal muscovite mica film.

The porous membranes formed from this process are referred to as track-etched membranes. The track-etched membrane pores are typically either conical or cylindrical in nature. Some unique pore geometries are also possible, such as wavy-along the length, random pore modulation, cigar shaped, etc. have been observed, but cannot be well controlled. The most common and adopted pores in nuclear track etched membranes are cylindrical. In this synthesis process, pore orientation and density is controlled during the bombardment process, where each accelerated particle corresponds to a single nuclear track that forms along the wake of the particle. Traditional track-etched membranes have a random arrangement of pores, but literature does give examples of ordered pores in track-etched membranes with appropriate selected particle bombardment techniques. Overall, the use of track-etched membranes in a TAES process allows for the fabrication of high-aspect ratio nanostructure arrays in a cost-effective and high-volume methodology.

An example of fabricating multi-layered track-etched membranes is discussed in U.S. Patent Appl. Pub. US2013/0228466, which is incorporated herein by reference. By fabricating multi-layers of either polymer or inorganic single-crystal films, a membrane with segmented pores can be formed. The pore diameters in the nuclear track process are dependent on the etching rates of the film's species, thus a multi-layered film that undergoes the nuclear track process will result in a porous membrane, where pore size or diameter varies between film layers.

This pore size modulation can be controlled through choice of materials and etchants. As a nonlimiting example, a Polymer-A/Polymer-B bi-layered film where both tracks are etched using the same etchant (e.g., Polymer-Etchant) will result in a modulated pore that varies in size or diameter between film-layers at a constant ratio. Another example is a Polymer/Inorganic Single-Crystal bi-layered film, where the polymer tracks are etched with a first etchant (e.g., Polymer-Etchant), and the inorganic Single-Crystal is etched with another etchant (e.g., Crystal-Etchant). This would result in a modulated pore where the pore size or diameter for each layer is controlled independently. Complex modulated porous membranes can then be produced through use multi-layers of polymer and inorganic single-crystal films, which undergo the nuclear track process.

### SUMMARY OF INVENTION

In one embodiment, a template assisted electrochemical synthesis (TAES) may be utilized to produce an exposed segmented nanostructure array (ESNA). The ESNA may comprise a conductive substrate, an insulating membrane layer, and an array of partially exposed segmented nanostructures. The insulating membrane layer may separate the conductive substrate from the exposed portions of the segmented nanostructures. The embedded portion of the segmented nanostructure may contact the conductive substrate.

The ESNA may be produced by electrochemical deposition process utilizing a multi-layered membrane affixed to a conductive substrate as a template, where the multi-layered membrane has layers with pores corresponding to the dimensions of the desired segments of the segmented nanostructure. After the deposition of material in the pores of the multi-layered membrane, one or more layers of the multi-layered membranes may be dissolved to expose a portion of the segmented nanostructures, but another portion of the segmented nanostructures remains embedded in a undissolved portion of the multi-layer membrane. When capped or core-shell ESNAs are desired, the deposition may be separated into multiple steps along with independent layer dissolution to achieve the desired segmented nanostructure.

The foregoing has outlined rather broadly various features of the present disclosure in order that the detailed description that follows may be better understood. Additional features and advantages of the disclosure will be described hereinafter.

### BRIEF DESCRIPTION OF THE DRAWINGS

For a more complete understanding of the present disclosure, and the advantages thereof, reference is now made to the following descriptions to be taken in conjunction with the accompanying drawings describing specific embodiments of the disclosure, wherein:

FIGS. 1A-1B respectively show nuclear track pores formed in a polycarbonate film and in a single-crystal muscovite mica film;

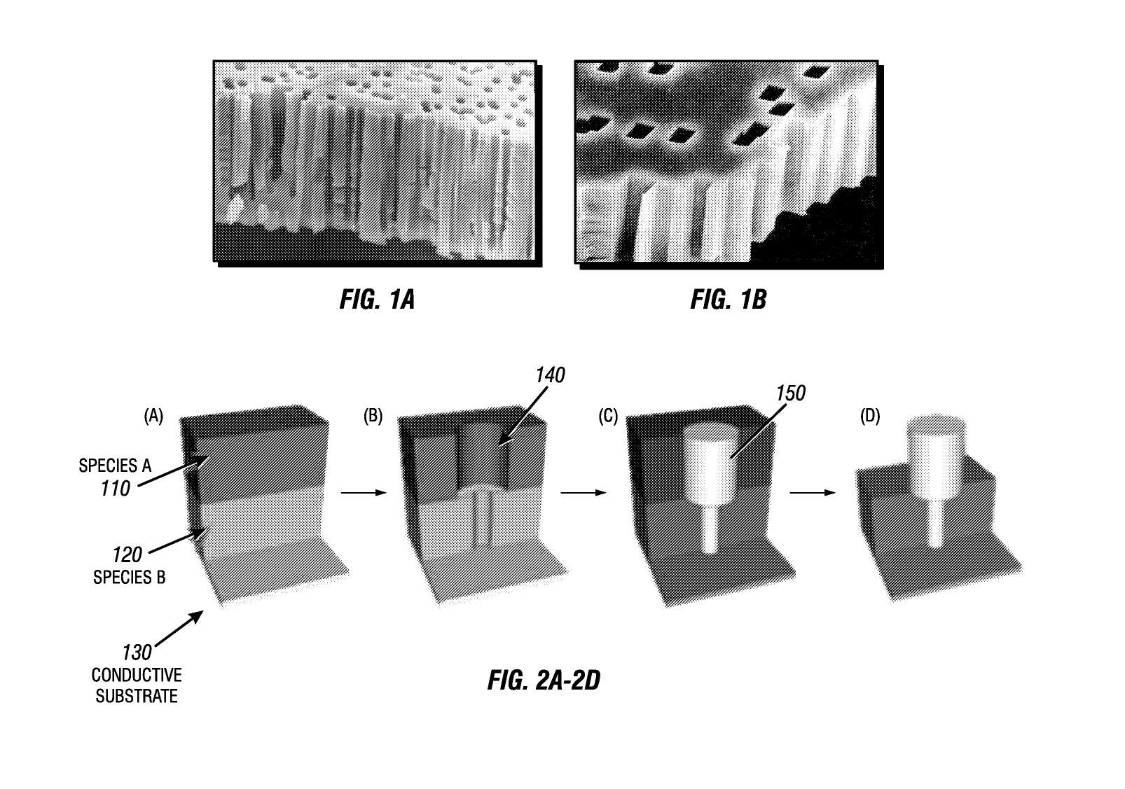

FIGS. 2A-2D show sectional diagrams of the fabrication process for homogeneous ESNAs;

FIGS. 3A-3D show procedures for forming composite exposed segmented nanostructure arrays (ESNAs);

FIGS. 4A-4B respectively show a current v. time curve for electrochemical deposition and a photograph of a sample after deposition;

FIGS. 5A-5B show SEM micrographs of ESNAs prototypes produced from TAES;

FIG. 6 shows a graph of PC and PET segment diameters versus etching time for segmented nano structures;

FIGS. 7A-7D show Core-Shell ESNAs, particular hemispherical (7A-7B) and coated ESNAs (7C-7D);

FIG. 8 shows a Composite Capped-ESNA;

FIGS. 9A-9B show commercially available track-etch membranes;

FIG. 10 shows an example of reel-to-reel fabrication of ESNAs.

### DETAILED DESCRIPTION

Refer now to the drawings wherein depicted elements are not necessarily shown to scale and wherein like or similar elements are designated by the same reference numeral through the several views.

Referring to the drawings in general, it will be understood that the illustrations are for the purpose of describing particular implementations of the disclosure and are not intended to be limiting thereto. While most of the terms used herein will be recognizable to those of ordinary skill in the art, it should be understood that when not explicitly defined, terms should be interpreted as adopting a meaning presently accepted by those of ordinary skill in the art.

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

Exposed Segmented Nanostructure Arrays (ESNAs) and methods of manufacturing ESNAs are discussed herein. In some embodiments, multi-layered membranes are used as templates for large area, high density arrays of nanostructures fabrication using electrochemical synthesis. As a nonlimiting example, multi-layered track-etched membranes discussed in U.S. Patent Appl. Pub. US2013/0228466 may be utilized. Multi-layered membranes may be formed from multiple layers of different materials. It shall be noted that bi-layered membranes are an example of multi-layered membranes, and thus, it shall be understood by one of ordinary skill that embodiments or examples discussing bi-layered membranes are equally applicable to multi-layered membranes. The material of each layer may be selected in accordance with the pore shape desired, etching rate, ionization potential, etc. The pores in the membrane may be formed from track etching, but unlike conventional membranes, each pore is segmented or has different dimensions corresponding to the different materials of each layer. As a nonlimiting example, a bi-layer membrane may have segmented cylindrical pores where a top portion of the pore is cylinder with diameter Dₜ and thickness corresponding to the thickness of a top layer, and a bottom portion of the pore is another cylinder with a diameter D_{b} and a thickness corresponding to a thickness of a bottom layer. It shall be clear to one of ordinary skill in the art that a multi-layer membrane with any number of layers may be utilized with any suitable combination of materials that are capable of producing desired pore shapes. In some embodiments, the segmented pores of a multi-layer membrane are produced from a single stage of exposure and etching, and do not require multiple exposures and etching stages.

Once the desired multi-layer membrane is formed, the desired segmented nanostructures can be formed by depositing desired material(s) in the pores, such as by electrochemical deposition, chemical vapor deposition (CVD), thermal deposition, or the like. In some embodiments, the segmented nanostructures may be overfilled to form a structure that extends beyond a top layer of the membrane, such as a dome or the like. In some embodiments, the segmented nanostructures may be a composite formed from two or more materials. In some embodiments, the segmented, composite nanostructure may comprise multiple regions or layers with different materials or a multi-material nanostructure. As a nonlimiting example, a multi-material nanostructure may be capped, or more specifically, the bottom region of the nanostructure may be formed from a different material than a top region of the nanostructure. In some embodiments, the multi-material nanostructure may be shelled or at least a portion of the nanostructure may be covered by one or more layers of material that is different from main body of the nanostructure. As a nonlimiting example, the shelled nanostructure may have a main body formed from a first material, and top portion of the main body may be covered by a second material that is different from the first material. In some embodiments, a nanostructure may be overfilled, a composite, capped, shelled, or a combination thereof. In some embodiments, rather than dissolving the entirety of the membrane, these nanostructures can be partially exposed by selective removal of the top or bottom layer of membrane material, whereas the unexposed portions of the nanostructures remain embedded in the unremoved layer of membrane material. The resulting exposed segments of the nanostructures are aligned and open to environment. These ESNAs can be formed on various substrates, including both rigid and flexible substrates.

The shape and composition of the ESNAs can be adjusted by modifying the electrochemical or other synthesis and manufacturing techniques. This approach allows for high level of control over nanostructure size, density, geometry density, composition, and orientation, while maintaining fabrication accuracy and repeatability. Further, the fabrication process is also compatible with batch or reel-to-reel processing. The fabrication process does not involve any highly toxic chemicals. The resulting ESNAs may have applications in energy storage, energy generation, electronic sensors, field-emissions, piezoelectrics, catalysts, and other materials science and engineering fields.

Improvements discussed herein can overcome problems in producing large quantity of nanostructures with controllable size, composition with geometries difficult to obtain by conventional methods. These methods are also compatible with batch manufacturing processing. In some embodiments, the use of bilayer porous membrane and electrodeposition, may allow vertically aligned nanomaterial arrays with controllable density, geometry, size, and composition modulation to be reproducibly and cost-effectively fabricated. The bilayer membrane with different chemical properties also allows for the partial exposure on the nanostructures while maintaining their alignment, and further manufacturing based on exposed nanostructure can be used to produce complicated structures and compositions to introduce other functionalities. These improvements allow the fabrication of vertically aligned nanostructure arrays; the fabrication of non-cylindrical nanostructures with complicated shapes, composition modulation and functionalities; easy control of nanostructure size, composition, and alignment; and cost effectiveness, high yield, and compatibility with batch production.

A new novel method of fabricating nanostructure arrays that is both cost and time efficient has been developed using a multi-layered track-etched membranes. Using a multi-layered track-etched membrane as a template for template assisted electrochemical synthesis or electrodeposition (TAES) of nanostructures, large arrays of segmented nanostructures can be developed. In some embodiments, the multi-layered membranes may be produced as discussed in U.S. Patent Appl. Pub. US2013/0228466. In some embodiments, these segmented nanostructures can then be partially exposed by selectively dissolving away at least one layer of the multi-layered membrane. This results in an array of high-aspect ratio nanostructures that are partially embedded in substrate, such as an insulating film, while a section of the segmented nanostructures is open to the environment. It has been further demonstrated that through a combination of secondary and tertiary deposition steps, composite, multifunctional, and surface functionalized ESNAs can be fabricated. In summary, the ESNAs allow for the modular design of composite arrays of nanostructures that are partially embedded in an insulating film, with capabilities for use in a wide range of fields such as: energy storage, energy generation, electronic sensors, field-emissions, piezoelectrics, catalysts, and other materials science and engineering fields.

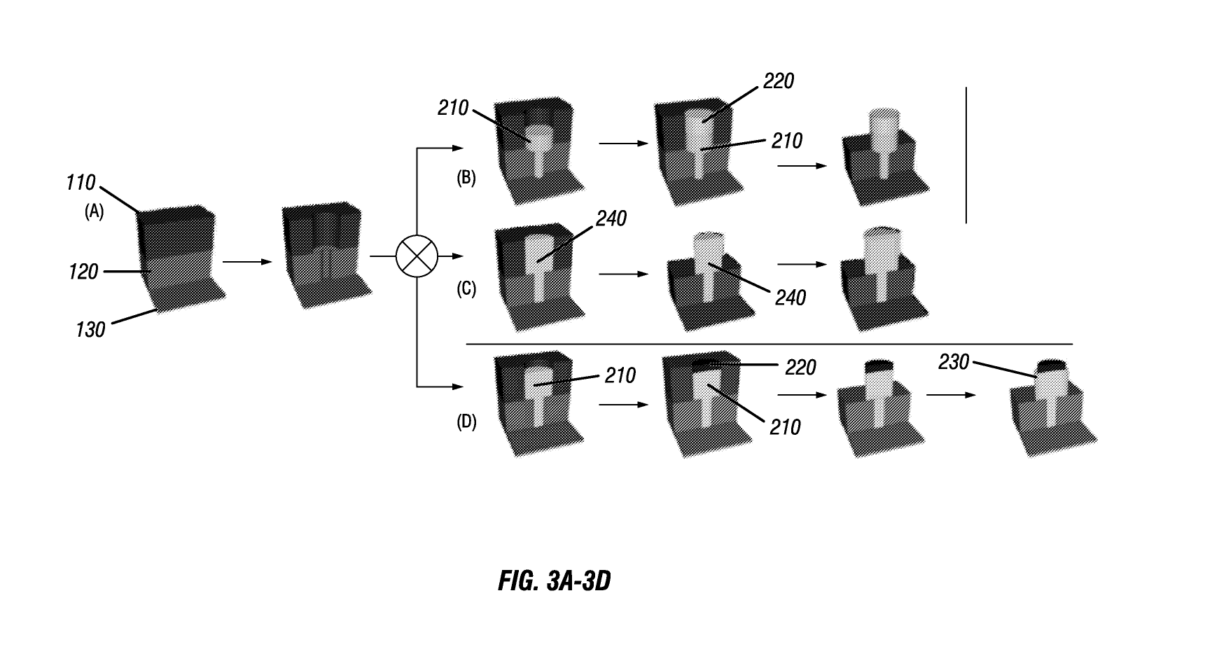

FIGS. 2A-2D show cross-sectional diagrams of the fabrication process for homogeneous ESNAs. A new type of nanostructure array can be fabricated utilizing multi-layer track-etched membranes that allows for the cost-efficient and time-efficient production of nanostructure arrays with unique physical properties. This novel nanostructure array is made by having a multi-layered film, such as, but not limited to, Polymer/Polymer or Polymer/Inorganic Single-Crystal film, that undergoes processing to form a multi-layer porous membrane, such as a nuclear track process to form a multi-layered track-etched membrane. The membrane may include a conductive substrate or may be affixed to a conductive substrate afterwards. As a nonlimiting example, FIG. 2A shows a bi-layered film of two different species 110 and 120, being either polymer or inorganic single-crystal films, affixed to a conductive substrate 130. FIG. 2B shows the bi-layered film after it undergoes the nuclear track process to form segmented or modulated pores 140. As shown, the pore provides a first cylindrical region corresponding to species A 110 that has a diameter Dₜ and height corresponding to the thickness of species A, and a second cylindrical region corresponding to species B 120 that has a diameter D_{b} and height corresponding to the thickness of species B. While the segments of the pores shown are two circular cylinders of different dimensions, in other nonlimiting examples, the segments of the pores may be cubes, rectangular boxes, and the like. In some cases, the three-dimensional shape may be frustum shaped version of the abovenoted shapes. This membrane is then used as a template for the TAES of segmented nanostructures. In some embodiments, the nanostructures may be formed utilizing the pores of the membrane utilizing any suitable deposition process, such as electrochemical deposition, chemical vapor deposition (CVD), thermal deposition, or the like. As a nonlimiting example of the various deposition options, FIG. 2C shows the bi-layered film being utilized for TAES to fill the pores and form a segmented nanostructure 150. Similar to the pores they form in, a segmented nanostructure may comprise two or more segments, where each segment is defined by a shape with different dimensions. For example, a segmented nanostructure may be defined by three-dimensional shapes, such as a cylinder, hexahedron, polyhedron, or any other suitable shape, that are stacked on top of each other. In the example shown, the segments of the nanostructure are two circular cylinders of different dimensions, but in other nonlimiting examples, the segments of the nanostructures may be, cubes, rectangular boxes, and the like. In some cases, the three-dimensional shape may be frustum shaped version of the abovenoted shapes. In some embodiments, these segmented nanostructure arrays can then be further exposed beyond just the top surface of the nanostructure by selectively dissolving one or more layer of the multi-layered track-etched membrane. However, the segmented nanostructures are only partially exposed as some layers of multi-layer membrane are not dissolved. For example, FIG. 2D shows the top-film layer or species A 110 selectively dissolved away to further expose the segmented nanostructure 150, while the nanostructures remain embedded in bottom layer or species B 120, which was not dissolved. This allows for the fabrication of vertically-aligned nanostructure arrays that are partially-embedded in a substrate, such as an insulating film, which is referred to herein as Exposed Segmented Nanostructure Arrays (ESNAs). The remainder of the undissolved layer(s) of the multi-layered film, such as the polymer or inorganic single-crystal layer, insulates the conductive substrate from the environment, while the unexposed segment of the nanostructure may maintain the electric conductivity between the nanostructures in the array.

These ESNAs differ from traditional nanostructure arrays, in both their means of fabrication, and the arrangement of the nanostructure. Traditional track-etched membranes can be used for the fabrication of nanostructure arrays, but are limited due to the track-etched membranes being composed of only a single layer. This limits the nanostructure arrays to be composed of 2-D nanostructures that are either embedded in the track-etched membrane, or fully exposed through dissolution of the membrane. Controlled partial exposure of the nanostructures is not achievable. Other methods of manufacturing nanostructure array templates, such as e-beam lithography or AAO templates, require very fine tuning to achieve control over nanostructures, and have a very low throughput and are comparatively expensive methodologies.

In some embodiments, the ESNA provides a conductive substrate and film layer(s), which may be insulating layer(s). In some embodiments, the segmented nanostructures are embedded in the film layer and may extend through the insulating layer(s) to conductive substrate to provide electrical coupling. However, in other embodiments, the conductive layer may not be electrically coupled to the nanostructures, such as from a result of processing to produce the ESNA, removal of the conductive layer, flexing, or any other suitable processing. The conductive substrate and segmented nanostructures may be formed of any suitable conductive material, and the insulating layers may be formed from any suitable insulating materials. The segmented nanostructures may be cylinders, tubes, hexahedrons, or polyhedrons, where the dimensions (e.g., length, width, height, diameter, etc.) of the shapes are nanoscale. One or more of the segmented nanostructures in the ESNA may be partially exposed. As an example, one or more segments of the segmented nanostructures may be exposed to the surrounding environment, but at least one portion of the segmented nanostructures remains embedded in film layer(s). The nanostructures can be arranged either periodically in a pattern or randomly with user defined control over the density of the number of nanostructures in the array. The multi-layered track etch templates thickness is also variable, with dimensions ranging in the nano-scale to micro-scale. As such, in some embodiments, the height of the nanostructures may be micro-scale. Notably, the structures shown herein cannot be produced using single layer nuclear templates. Further, this technique also allows the use of a deposition technique, such as but not limited to electrochemical deposition to electrochemically deposit nanostructure as electrodes for fabricating other non-cylindrical nanomaterials.

The film layer or insulation layer that the segmented nanostructures are embedded in allows for only the exposed section of the nanostructures to be exposed to the environment and therefore be used in an electrochemical or chemical application. Traditional nanostructure arrays have the nanostructures affixed directly to a substrate without any portion of the nanostructure embedded, which can interfere with measurements or processes due to unwanted secondary reactions. In electrochemical sensors, this becomes evident through increased background signal, higher noise, and false-sensing due to non-desired reactions/measurements.

The geometry of the exposed nanostructure can be: cylindrical, tubule, or conical through control of the etching of the top-layer of the bi-layered membrane, with nanoscale dimensions. As a nonlimiting example, the dimensions (e.g. length, width, or diameter) of the nanostructure may range down to 15 nm. In some embodiments, the dimensions of the nanostructure may be 50 nm or less. In some embodiments, the dimensions of the nanostructure may be 15 nm or less. The height of the nanostructures is determined by the multilayer thickness and high energy particle penetration depth. The composition of the exposed nanostructures is controlled through the deposition process. Pore density and orientation can also be controlled through the heavy particle bombardment stage in the nuclear track process.

Given a multi-layered film, such as Polymer/Polymer or Polymer/Inorganic Single-Crystal, the ESNAs features can be tailored by the users due to the each nanostructure feature being independently controlled through the processes, such as pore density through ion bombardment dosage; nanostructure orientation through ion bombardment angle, pore shape/size through etching conditions; final nanostructure height through top-layer film thickness and/or electrochemical deposition time; and/or nanostructure species through electrochemical deposition. This modular fabrication process allows for a wide range of nanostructures to be fabricated using the same techniques with minor modifications of individual processing stages.

The fabrication process also is compatible with reel-to-reel or batch mass fabrication without ultra-high vacuum systems or highly-toxic chemicals. Track-etched membranes are already being commercially produced (e.g., GE Life Sciences Nuclepore membranes). These membranes, used primarily for filtration purposes, are fabricated through exposing sheets of polymer films to the fission-fragments of a nuclear reactor or alpha-radiation source, followed by baths in chemical etchants to develop the pores. Improved techniques discusses herein allow similar exposure and etching techniques to be used along with deposition baths and solvent baths to fabricate ESNAs on an industrial scale.

In some embodiments, the TAES process discussed herein can be used to fabricate more than homogeneous ESNAs, and can also be used as a unique platform for the fabrication of composite nanostructures, which is formed from two or more different materials. For the sake of brevity, prior processing steps are not repeated here, but it shall be apparent that some of the prior processing steps utilized for homogenous ESNAs may also be performed to produce composite ESNA discussed herein. In some embodiments, the TAES processes discussed above can be adjusted to produce alternating layered nanostructures through control of deposition bath design and deposition conditions. As a nonlimiting example, this alternating layered nanostructure is also possible with the bi-layered track-etched template. This alternating deposition can also be used to create capped nanostructures, through a secondary deposition process prior to top-film dissolution. These capped and multi-layered nanostructures offer unique electric, chemical, and optical effects, and can allow for multifunctionalization.

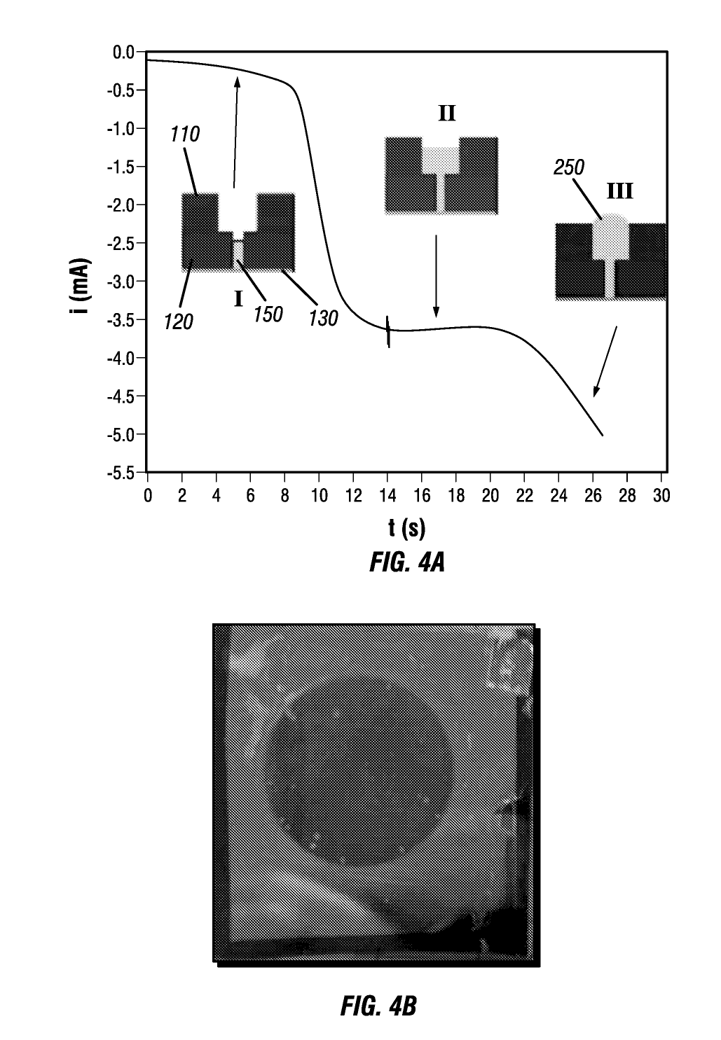

FIGS. 3A-3D show procedures for composite ESNAs. FIG. 3A shows a bi-layered modulated porous membrane used as the template for the TAES that provides a top layer 110, bottom layer 120, and conductive substrate 130. Segmented pores may be formed as discussed previously above. FIG. 3B shows a sequence of subsequent steps for creating alternating-layered or capped ESNAs, where the composition of the nanostructure alternates between different material. After deposition of a first material 210 to partially fill the pore, the electrolyte solution or deposition parameters may be adjusted to filling the remaining portion of the pore with a second material 220. Subsequently, the top layer of the porous membrane may be dissolved if desired. The amount of the first material 210 and second material 220 may be adjusted as desired by adjusting the deposition parameters. Further, in other embodiments, additional deposition steps may be added if more than two layers are desired.

FIG. 3C shows a sequence of subsequent steps for forming core-shell ESNAs after formation of the porous multi-layer membrane as shown in FIG. 3A. Core-shell ESNAs provide a layer or shell 230 of a different material that surrounds or covers a portion of the underlying segmented nanostructure 240, such as an exposed portion of the segmented nanostructure. The core-shell ESNAs are created by forming a homogeneous segmented nanostructure 240 from a first material, and the dissolving away one or more layers of the multi-layer membrane, but not all of the layers, to expose a portion of the nanostructure, while leaving a portion of the nanostructure embedded in undissolved layer(s), such as shown in FIG. 2A-2D. For example, the top-film layer 110 may be dissolved to partially exposure the nanostructure. The homogeneous ESNA is then used as a scaffold for additional deposition with another different material to coat the exposed segment of the nanostructure and form shell 230. It should be noted that the shell or coating layer 230 for the partially exposed nanostructure allows for a greater variety of deposition options, such as electrodeposition, CVD, thermal deposition, liquid phase deposition (LPD), or any other suitable deposition process.

In some embodiments, the alternating layer/capped ESNA and the core-shall ESNA methodologies discussed above can also be combined to form a unique nanostructure, represented in FIG. 3D. As discussed in reference to FIG. 3B, an alternating-layered or capped segmented nanostructure may formed by partially filling the pore with a first material 210 and filling the remaining portion of the pore with a second material 220. Subsequently, layer(s) of the multi-layered membrane (e.g. top layer 110) may be dissolved to leave at least one layer that a portion of the segmented nanostructure is embedded in, whereas the other portion of the segmented nanostructure is exposed. Similar to the process discussed in reference to FIG. 3C, a coating, shell, or layer 230 may be deposited partially or fully on the exposed portion of the segmented nanostructure shown in FIG. 3D by additional electrochemical deposition. In cases where a portion 220 of the segmented nanostructure is nonconductive, the coating or shell 230 does not cover the nonconductive portion during the additional electrochemical deposition. For example, in the example show in FIG. 3D, the segmented nanostructure is capped by a semiconductive material 220. As a result, the coating 230 formed from another electrochemical deposition only coats the exposed section of the conductive lower portion 210 of the segmented nanostructure, whereas the semiconductive cap 220 remains uncoated.

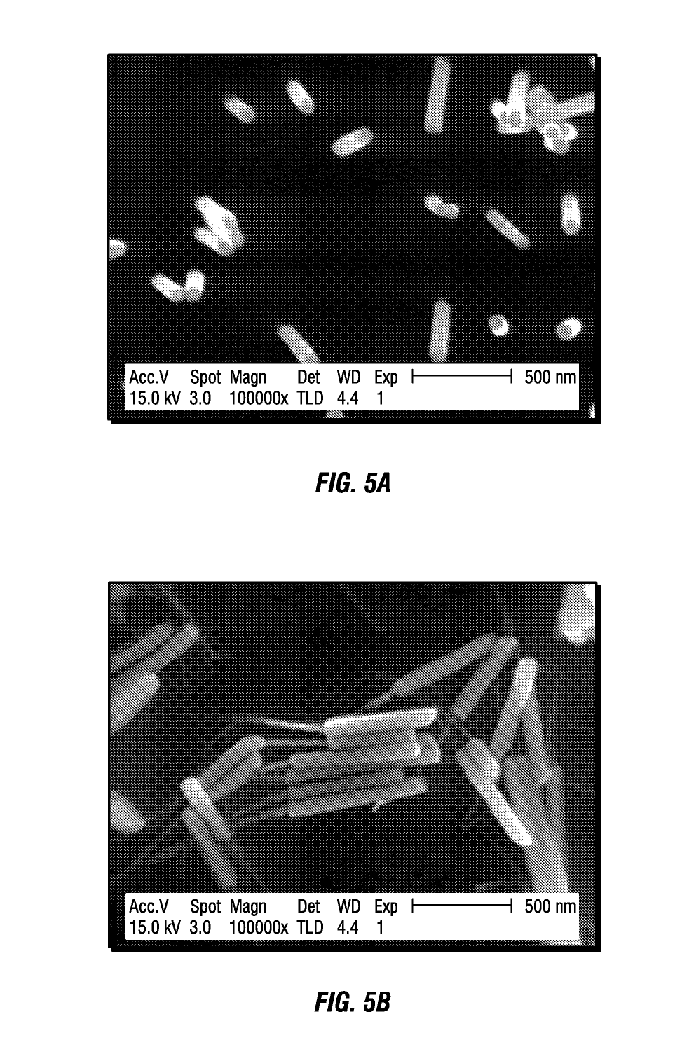

In some embodiments, more complex and unique nanostructures are also possible using the methods discussed herein. In some embodiments, complex and unique nanostructures are possible with the ESNAs due to their unique insulation of the conductive substrate, which allows for using the ESNAs as a scaffold for other nano-/micro-structures. In some embodiments, deposition of material may extend beyond filling the pore to form a desired shape on a tip of the nanostructure. As a non-limiting example show in FIG. 4A, a domed segmented nanostructure may be formed. As in other embodiments, the multi-layer porous membrane may provide top layer 110, bottom layer 120, and conductive layer 130. Additionally, material 150 is deposited into the pores utilizing electrochemical deposition as illustrated by the stages I-III shown. In contrast to the other embodiments, deposition progress beyond filling the pore as shown in stage III to produce a domed portion 250. As shown, the domed portion 250 extends beyond the top layer 110 to provide a hemispherical top. This domed segmented nanostructure show may be produced by extending deposition beyond an amount needed to fill the pore, or performing another deposition step after the pore is fully filled. Other nonlimiting examples of nanostructures that are possible by altering the etching characteristics or template properties that are possible include, but are not limited to, nanostructures shaped to form branched antennas, pyramidal, cigar shaped, modulated diameters, hexagonal, rectangular, conical, or disc shaped exposed nanostructures. Similarly, in some embodiments, the tip portion of the nanostructure may also form such shapes in accordance with etching characteristics or template properties. In addition to the nonlimiting embodiments discussed above, any combination of materials may be utilized to form nanostructures that may be multi-layered or capped, with a shell, or any combination thereof, such as by utilized the methods discussed previously.

In some embodiments, composite nanostructures are possible using the ESNAs as the working-electrode during a secondary electrochemical deposition stage or after the top-layer film has been dissolved. Due to the conductive substrate and a portion of the nanostructure remaining insulated, the secondary deposition will only occur on the exposed segment of the nanostructures. It should also be apparent that these other nano-/micro-structures may optionally be combined with the multi-layered and/or shelled nanostructures discussed previously. As a nonlimiting example, a secondary coating can be deposited on the exposed segments of the nanostructure to form the core-shell nanostructures. In other embodiments, the secondary deposition can deposit a large amount of material to allow approximately hemispherical antennas to grow from the exposed nanostructure. In some embodiments, these nanostructures can also be selectively surface functionalized through either an electrochemical or chemical process, while the conductive substrate and unexposed regions of the nanostructure remains unaffected by these processes. This surface functionalization can include coating the surface of the exposed section of the nanostructures with an organic or inorganic species, or altering the surface properties of the exposed section of the nanostructures to change the materials properties. In some embodiments, other electrochemical/chemical processes can also be used to make unique nanostructures, such as de-alloying to make controlled segments of the segmented nanostructures in the array porous, or anodization to passivate the surface of the nanostructure. As a nonlimiting example, at least a portion, an entire segment, or the entirety of a segmented nanostructure may be porous. In short, ESNAs can be utilized as a nano-scaffold electrode for many types of electrochemical and chemical processes that can result in composite nanostructures with multi-functionalization and unique physical and chemical characteristics.

Unique nanostructures that were not possible with traditional TAES, are now possible with the improved processes discussed herein, including alternate layered or capped nanostructure deposition of the ESNAs, secondary post-dissolution deposition for core-shell ESNAs, selected surface functionalization, and other electrochemical fabrication. Similar nanostructures formed from other methods would typically require complex multi-stage processes that reduce the throughput and increase costs greatly, whereas the processes described herein only requires additional electrochemical baths. Furthermore, these processes can reduce the costs of manufacturing of composite nanostructures by reducing the wasted deposited material. Traditional nanostructure arrays that undergo any secondary deposition process, have wasted material, due to the deposition being uniform across the whole sample, such as on an exposed electrode that is not part of the final end product, and not just across the nanostructures of the array.

The nanofabrication of high-aspect nanostructures typically requires highly expensive equipment, the use of toxic chemicals, or the use of a process that is time inefficient. The systems and methods discussed herein use an industrial safe process with a new methodology that results in equivalent nanostructure arrays as competitive processes, but at a much lower cost and with higher throughput. This fabrication process is modular, allowing for tailored design of nanostructure arrays, without drastically changing the overall fabrication process. The ESNAs have the potential to be used for the development of consumer and research based technologies that would rely on nanostructure arrays.

An advantage of this technology is also its capability for composite, multifunctional, and surface-functionalized nanostructures in a unique and novel methodology. Traditional nanostructure arrays, once released from their template can only be coated using methods that would coat the whole sample surface, including the substrate, causing a waste of materials. These coatings are also un-uniform and result in nanostructures that may have imperfect surface qualities. Our method of utilizing the ESNAs as a scaffold for electrodeposition allows for a high level of control over final nanostructures physical and chemical surface properties through control of electrochemical and chemical processes that selectively affect only the exposed segment of the nanostructure.

This partial exposure of the ESNAs is unique among nanostructures. This unique partial exposure allows for the electrical and chemical insulation of the substrate, thus partially exposing only exposed segments of each of the nanostructures of the nanostructure array to the environment, and therefore toward any process or measurement. This feature allows for more selective electrochemical measurements when using the nanostructures in sensors, and also allows for the composite fabrication of ESNAs. This selectivity is also useful for analytical and research purposes, since it can be used to explore the effects of chemical and electrochemical processes purely on a nanostructure's surface. Results would not interfere with non-desirable reactions that could occur at the supporting electrode.

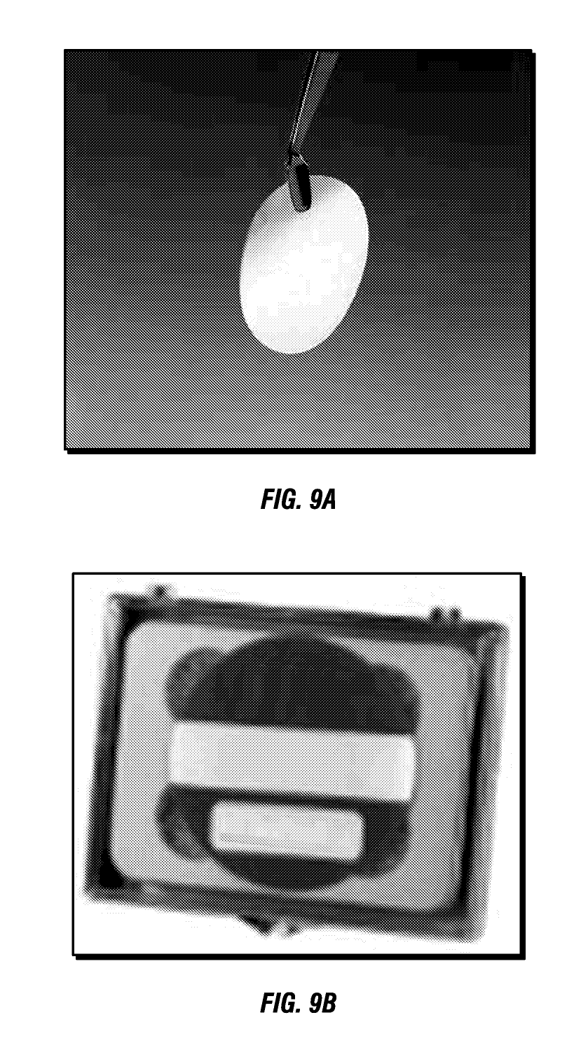

The nuclear track process is already utilized for the commercial fabrication of polymer membranes, such as GE Life Sciences and Whatman. FIGS. 9A-9B show commercially available track-etch membranes produced by Whatman and GE-Life sciences (Nuclepore). These commercial membranes have uniform pores and membranes are composed of either PC or PET. These companies utilize nuclear reactor's fission-fragments to create nuclear tracks in polymer films that are then etched to form porous membranes. These membranes are used commonly in cell-culturing, filtration devices, and for the fabrication of nanostructure arrays.

The ESNAs fabrication methods utilize scalable techniques for fabrication, including this nuclear track process. The ESNAs fabrication would be similar to the fabrication of the porous membranes. However, ESNA fabrication differs from the fabrication process for these membranes in that it includes a bi-layer polymer film synthesized on a conductive substrate, an electrodeposition stage, and also a chemical bath to selectively dissolve away at least one layer of the multi-layer membrane.

Referring back to FIGS. 3A-3D and 4A, it shall be apparent that a variety of nanostructures or ESNAs can be produced utilizing the various processing options discussed herein. The segmented nanostructures produced may have a bottom portion embedded in layer 120, which may be a nonconductive or low conductivity dielectric material. In some case, the conductive layer 130 that layer 120 is on top of may be useful for the desired device. In other cases where only the nanostructures are desired, layers 120 and 130 may be removed, such as by etching. While this example discusses bi-layered membranes, some embodiments may utilize multi-layered porous membranes. As such, one or more layers of the membrane may be removed and/or the segmented nanostructures may be embedded in one or more layers. In some embodiments, the nanostructure may be overdeposited so that the tip forms a desired shape. In some embodiments, nonlimiting examples of the shape of the nanostructures may be a dome, branched antennas, pyramidal, cigar shaped, modulated diameters, hexagonal, rectangular, conical, or disc-shaped. In some embodiments, the desired shape formed on the tip may optionally be formed from a different material. Further, the top portion of the nanostructure that is exposed may be covered by a shell of a different material than the nanostructure. In some embodiments, the nanostructure may provide a first region formed from a first material and a second region formed from a second material. Optionally, the top portion of the nanostructure is covered by a shell comprising a third material. In some embodiments, the first material is conductive and the second material is nonconductive. It shall also be recognized that in embodiments where the nanostructure comprises two or more materials, the nanostructure may also be overdeposited so that the tip forms a desired shape as discussed previously. Further, these composite nanostructures may also be optionally coated with a shell. As noted previously, when a nonconductive material in present during electrochemical deposition of a shell, this nonconductive portion may remain uncoated.

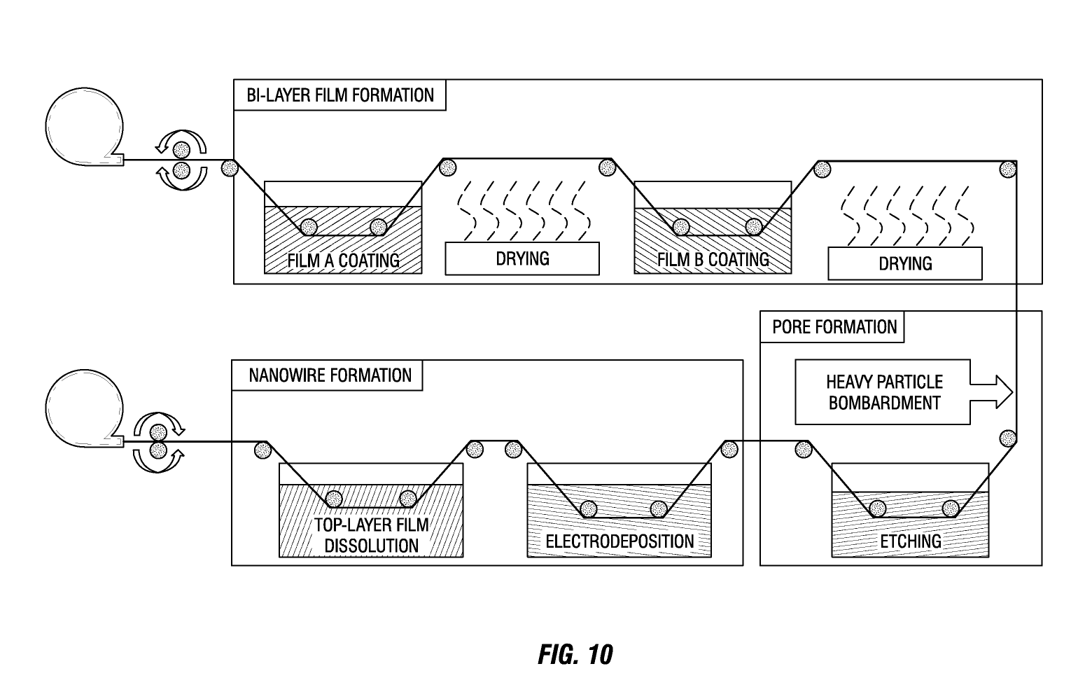

ESNAs can become a powerful new tool in large scale nanomanufacturing of nanostructure arrays. The use of bi-layer track-etched membranes for the fabrication of homogeneous and composite nanostructure arrays, allow for the modular design of nanostructure arrays based off users need. The nuclear track process and TAES are also compatible with reel-to-reel and mass batch fabrication techniques. A reel-to-reel fabrication system could be utilized for the continuous fabrication of ESNAs on a flexible substrate. FIG. 10 shows a nonlimiting example of reel-to-reel ESNA fabrication that would allow for continuous fabrication of homogeneous ESNAs on a conductive flexible substrate. Fabrication is broken into three distinct phases: Multi-Layer Film Formation (e.g., example shown uses two-polymer species that can be dip-coated), Pore Formation (e.g., nuclear track process), and Nanostructure Formation (e.g., electrodeposition and film layer dissolution). The nonlimiting example illustrated may be modified in any manner discussed previously for providing desired segment nanostructure arrays. Modification of baths or ion bombardment will allow for control over final geometry, orientation, density, and composition of the ESNAs. Further, additional baths could allow for composite ESNAs. The fabrication can be split into different modules, which can each be adjusted to control individual variables of the ESNAs. For example, polymer solution casting stages can be adjusted to control film thickness and properties, ion bombardment can be adjusted to control nanostructure density and orientation, etching can be adjusted to control pore size, electrodeposition can be adjusted to control the species deposited, and secondary/tertiary electrodeposition/chemical baths can be adjusted to create composite, multifunctional, or surface-functionalized nanostructures.

These nanostructure arrays can be fabricated on flexible or stiff supporting electrodes. These nanostructure arrays may be partially embedded in polymer or inorganic single-crystal films, each offering unique electrical, chemical, and thermal properties. The fields of study that this device would be applicable too may include: biotechnology, electronics, display, environmental protection and waste-management, energy harvesting, and the energy storage fields. The ESNAs allow for the affordable mass-fabrication of composite nanostructure arrays with multifunctionality, which can be used for highly sensitive, and selective measurements or processes.

The fabrication of ESNAs of multiple types of compositions has been demonstrated with feature's dimension range of 15 nm to microns, but a wider range of dimensions is possible with modifications to material selection and the nuclear track process. Smaller and larger pores are possible, and can be accomplished by either choosing different polymers, higher energy ion, heavier ion, or modifying the chemical etching. Nonlimiting examples of materials that may be utilized for the fabrication of ESNAs may include gold, nickel, and/or zinc-oxide. This demonstrates the ability of the fabrication processes discussed herein to produce highly conductive metallic species, magnetic species, and/or metal-oxide-semiconductor species, each of which may have its own unique application. In some embodiments, the segmented nanostructures may be a composite structure such as, but not limited to, a core-shell, capped, or hemisphere-shaped structure. The ESNAs can result in segmented nanostructures such as, but not limited to, tubules, cones, wires/pillars, or hemispherical nanostructures.

### Experimental Example

The following examples are included to demonstrate particular aspects of the present disclosure. It should be appreciated by those of ordinary skill in the art that the methods described in the examples that follow merely represent illustrative embodiments of the disclosure. Those of ordinary skill in the art should, in light of the present disclosure, appreciate that many changes can be made in the specific embodiments described and still obtain a like or similar result without departing from the spirit and scope of the present disclosure.

Homogeneous ESNAs have been fabricated using a Polymer/Polymer bi-layer film that undergoes the nuclear track process, followed by TAES of gold (Au) (e.g. FIGS. 2A-2D). Bi-layers of Polycarbonate/Polyethylene-Terephthalate (PC/PET) were spin coated on Au-coated Si substrates. PET was spin coated first to act as the bottom-layer film, followed by PC spin coating, which acted as the top-layer film. PET was spin coated using a solution of 0.06 g/mL of PET in a solvent of CHCl₃+TFA at a volume ratio of 5:1. PET solution was spin coated at 3,000 rpm followed by baking overnight under vacuum at 150° C. PC was spin coated after PET was baked using a solution of 0.07 g/mL of PC in a solvent of CHCl₃. PC solution was spin coated at 3,000 rpm followed by baking overnight in vacuum at 150° C. This resulted in a PC/PET bi-layered film with a PC-layer thickness of 1.00 μm, and a PET-layer thickness of 0.75 μm.

PC/PET bi-layered films were then bombarded with heavy ions using Texas Center of Superconductivity at the University of Houston's (TcSUH's) linear tandem accelerator. The films were bombarded with Ni⁸⁺ particles at 16.5 MeV normal to films planar surface to a dosage of 1×10⁹ particles/cm². Following bombardment, films were etched using a solution of 6.25 mol NaOH under various times to create different sized segmented pores. NaOH acts as an etchant for both PC and PET nuclear tracks.

Electrodeposition was carried out using a three-electrode set-up, with platinum mesh acting as the counter electrode and Ag/AgCl acting as the reference electrode. Au-ESNAs were fabricated by using a commercial available Au Technigold electrolyte from Technic Inc. Deposition was carried out by heating the electrolyte to 65° C. and applying a potential of −0.7 V(Al/AgCl). Post deposition, samples top-layer of PC was dissolved away by multiple washings with CHCl₃. The CHCl₃ does not attack PET. Observing the current vs. time plot during the deposition of Au reveal an initial curve that is common with depositing material in a porous membrane, but there is an observable increase in current followed by a secondary plateau that corresponds to the abrupt pore diameter change between film layers.

FIG. 4A shows a current vs. time curve of electrodeposition of Au into a bi-layered modulated porous membrane of PC/PET that was etched for 15 minutes in 6.25 mol NaOH. Plot diagrams indicate regions of pore-filling during TAES, with current increase due to pore modulation and pore over growth corresponding to the dome formation of the Au nanostructure. FIG. 4B shows a photograph of sample after TAES. Segmented nanostructures were uniformly grown in the darkened cylindrical region of the sample.

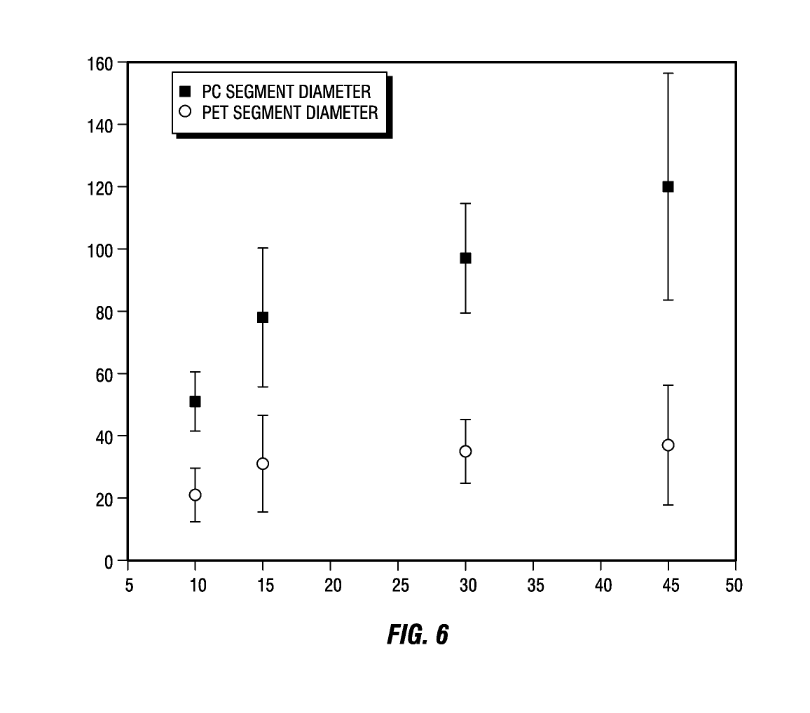

SEM imaging was used to characterize the morphology of the Au-ESNAs. FIGS. 5A-5B show SEM micrographs of Au ESNAs prototypes produced from TAES using bi-layer modulated porous membranes of PC/PET that was etched for 15 minutes in 6.25 mol NaOH as templates. FIG. 5A show ESNAs after top-layer of PC is selectively dissolved to partially expose the segmented nanostructure. Imaging revealed that the exposed section of the nanostructures were cylindrical in nature, and vertically aligned. Nanostructures appear to have a high uniformity among samples. FIG. 5B shows the fully exposed segmented nanostructure after dissolving away both the PC and PET film layers. The PC-segment corresponds to the smooth-walled cylindrical segment of the nanostructure, and the PET-segment corresponds to the more conical and smaller diameter rough segment of the nanostructure. The PET-pore shape is most likely due to the crystalline nature of the PET. Imaging also revealed that the PET did not have any cracks or damage from the dissolution of PC. To fully expose the segmented nanostructure, the PET layer was also dissolved by washing samples in TFA followed by SEM imaging to image the full nanostructure.

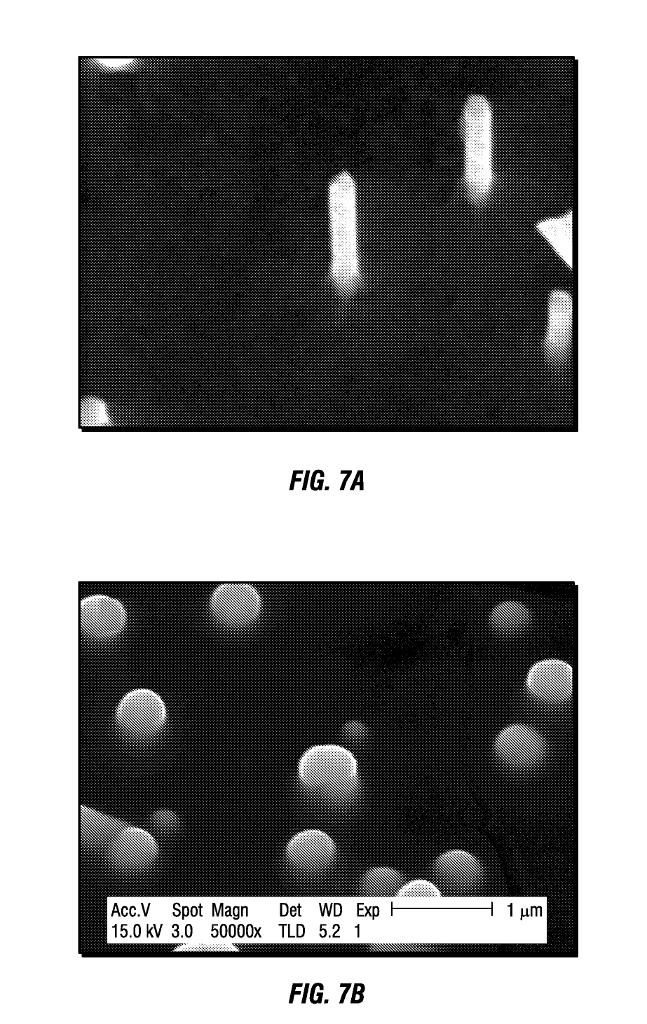

Image analysis of samples versus etching time reveals that PC-pore diameter can be controlled to be equal to or between approximately 50 nm to 125 nm, while PET pore diameter can be controlled to be equal to or between approximately 20 nm to 35 nm under etching times of 10 to 45 minutes. FIG. 6 shows a graph of PC and PET segment diameters versus etching time for segmented nanostructures formed from bi-layered modulated porous membranes of PC/PET etched in 6.25 mol NaOH.

Image analysis of samples also revealed that the segmented nanostructures had a total height of 1.3 μm, with the cylindrical-segment corresponding to 0.7 μm in height and the conical-segment corresponding to 0.5 μm in height, which roughly corresponds to the PC and PET film thickness. Shortening etching times did not produce full tracks, and therefore, was not viable for nanostructure fabrication. This was due to the limitation of our particle bombardment's low kinetic energy when compared to the energy of spontaneous fission fragments from radioactive sources, or charged ions from cyclotrons. If access to these sources or similar sources is available, thicker polymer films and different polymer species can be used, and lower diameter nanostructures with different pore geometries are possible.

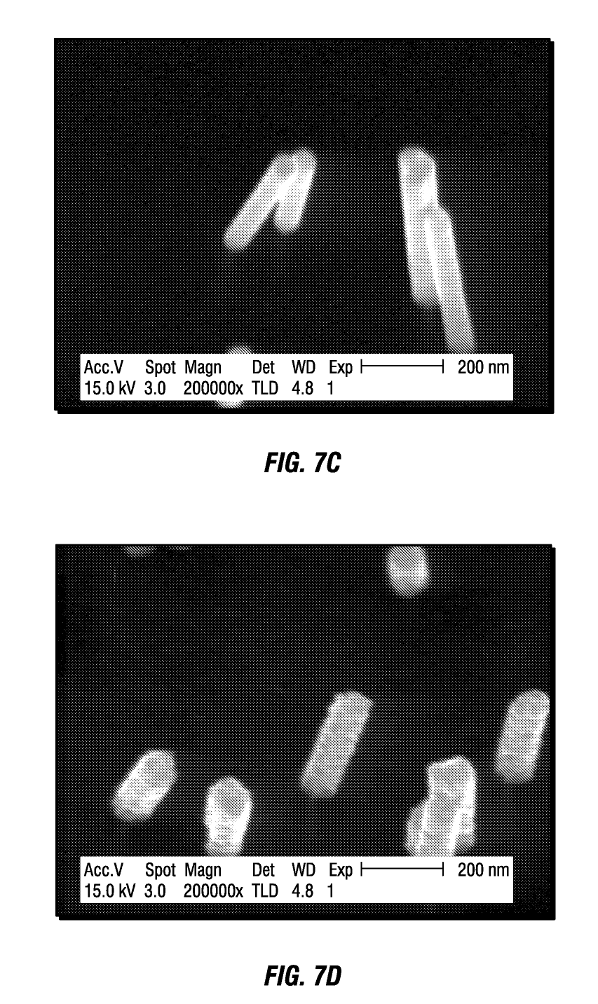

Core-shell ESNAs were also fabricated using Au-ESNAs as the platform for secondary deposition of nickel (Ni) (e.g FIG. 3C). Au-ESNAs were fabricated as discussed above, with an etching time of 15 minutes, resulting in average exposed segment diameter of 65 nm. The PC-film was dissolved using CHCl₃, and then Ni was deposited using the exposed Au segmented nanostructures as the working electrode. Core-shell Ni/Au ESNAs were fabricated under two conditions. FIGS. 7A and 7C are Au homogeneous ESNA with average diameter of 65 nm that are used as scaffolding for secondary Ni electrodeposition to form Ni/Au Core-Shell nanostructures in FIGS. 7C and 7D respectively. The first Core-Shell ESNA (e.g., FIGS. 7A-7B) used a Ni electrolyte composed of 1.0 mol NiCl₂ with an applied potential of −1.0 V(Ag/AgCl) for 60 seconds. This resulted in a hemispherical Core-Shell nanostructure, with a radius of approximately 250 nm. The second Core-Shell ESNA (e.g., FIGS. 7C-7D) was fabricated using 0.01 mol NiCl₂ with an applied potential of −1.0 V(Ag/AgCl) for 10 seconds, which resulted in a thin uniform 10 nm coating of Ni over the Au ESNAs.

This deposition process can be refined even more for even thinner core-shell nanostructures, or modified to produce multi-layered core-shell nanostructures. In some embodiments, the material that can be deposited is dependent on the electrochemical deposition process. Other deposition processes that may be utilized could include, but are not limited to, non-aqueous electrochemical deposition, chemical precipitation, and vapor deposition. These other deposition processes would still result in a core-shell nanostructure, but may not be as selective in their deposition process.

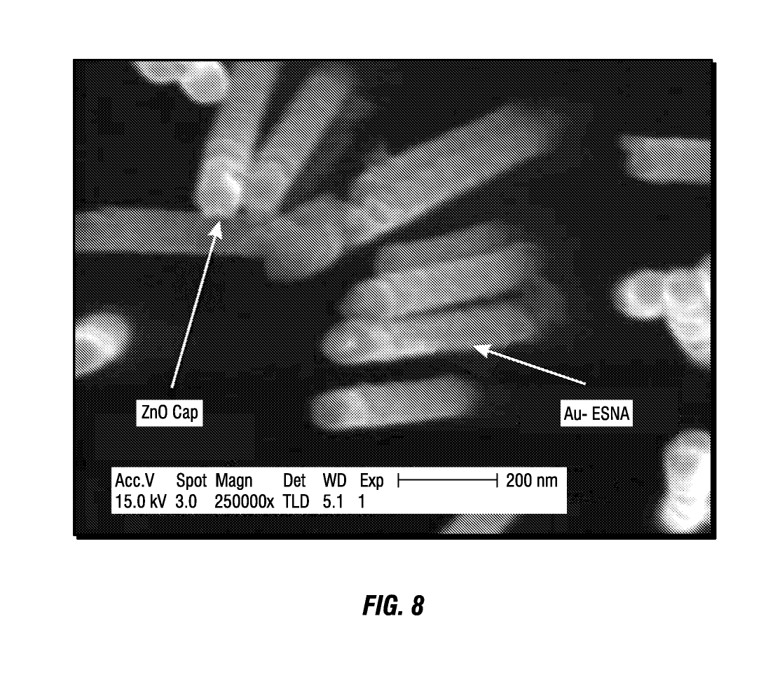

Capped ESNAs were fabricated using bi-layered track-etched templates as described above (e.g., FIG. 3B), such as with an etching time of 15 minutes. Au deposition as carried out with the bi-layered track-etched templates, but deposition was halted prematurely, resulting in the PC-pore only being partially filled. A capping layer of ZnO was deposited using an electrolyte of 0.1 mol ZnNO₃ heated to 65° C. with an applied potential of 1.1 V (Ag/AgCl). FIG. 8 shows a Composite Capped-ESNA fabricated by partially filling a PC/PET modulated porous template with Au to form Au-segmented nanostructures, followed by a secondary deposition of ZnO to form a capping layer. The composite nanostructure is then partially exposed by dissolving away the top-layer of PC. ZnO can be seen distinctly by the change in nanostructure's smoothness, and in the electrical conductivity (brightness) in the SEM micrograph. SEM imaging and correlating image brightness to conductivity reveal that the ESNAs have a highly conductive exposed base, which corresponds to Au, and a capped layer with lower conductivity that is believed to be the ZnO. As discussed previously above, the capped nanostructure may optionally be combined with the shell formation process.

Each of these prototypes demonstrate the capabilities of the fabrication of ESNAs discussed herein and their use for the fabrication of complex composite nanostructures. More complex nanostructures are also possible. The experimental examples discussed above demonstrate the ability to deposit a wide range of materials, such as highly conductive Au, magnetic Ni, and metal-oxide-semiconducting material ZnO. Each of these materials has unique applications in nanotechnology, and such composite structures would allow for multi-functional nanostructure arrays (e.g. conductive, magnetic, semiconducting, and catalytic).

Embodiments described herein are included to demonstrate particular aspects of the present disclosure. It should be appreciated by those of skill in the art that the embodiments described herein merely represent exemplary embodiments of the disclosure. Those of ordinary skill in the art should, in light of the present disclosure, appreciate that many changes can be made in the specific embodiments described and still obtain a like or similar result without departing from the spirit and scope of the present disclosure. From the foregoing description, one of ordinary skill in the art can easily ascertain the essential characteristics of this disclosure, and without departing from the spirit and scope thereof, can make various changes and modifications to adapt the disclosure to various usages and conditions. The embodiments described hereinabove are meant to be illustrative only and should not be taken as limiting of the scope of the disclosure.

What is claimed is:

1. A method for forming nanostructures, the method comprising:
forming a multi-layer porous membrane, wherein the membrane is formed from multiple layers of materials, and pores in the membrane are formed from track etching where each pore has different dimensions for pore regions corresponding to different materials;
depositing a first material in the pores of the membrane to form nanostructures, wherein the deposition of the first material extends beyond filling the pores to form a desired shape on a tip of the nanostructures; and
dissolving at least a portion of the membrane to further expose at least a portion of the nano structures.

2. The method of claim 1, wherein the membrane includes a metal layer, and the deposition of the first material into the pores is performed using electrodeposition.

3. The method of claim 1, further comprising depositing a second material to form a shell on the portion of the nanostructure that is exposed.

4. The method of claim 3, wherein the deposition of the second material to form a shell on the portion of the nanostructure that is exposed occurs after dissolving at least a portion of the membrane.

5. The method of claim 1 further comprising surface functionalizing the portion of the nanostructures that are exposed.

6. The method of claim 1, wherein the desired shape on the tip of the nanostructures is a dome.

7. The method of claim 1, wherein the nanostructures are shaped to be branched antennas, pyramidal, cigar shaped, modulated diameters, hexagonal, rectangular, conical, or disc shaped.

8. The method of claim 1, wherein at least a portion of the nanostructure is porous.

9. A method for forming nanostructures, the method comprising:
forming a multi-layer porous membrane, wherein the membrane is formed from multiple layers of materials, and pores in the membrane are formed from track etching where each pore has different dimensions for regions corresponding to different materials;
depositing a first material in the pores of the membrane to form nanostructures, wherein the deposition of the first material into the pores partially fills the pores;
depositing a second material into an unfilled portion of the pores; and
dissolving at least a portion of the membrane to further expose at least a portion of the nano structures.

10. The method of claim 9, wherein the membrane includes a metal layer, and the deposition of the first material into the pores is performed using electrodeposition.

11. The method of claim 9 further comprising depositing a third material, after the portion of the membrane is dissolved, to form a shell on the portion of the nanostructure that is exposed.

12. The method of claim 9, wherein the first material is conductive and the second material is nonconductive.

13. The method of claim 12, further comprising depositing a third material, after the portion of the membrane is dissolved, to form a shell on the portion of the nanostructure that is exposed, wherein the shell only coats the portion of the first material that is exposed.

14. The method of claim 9, wherein the first material and the second material are conductive.

15. The method of claim 9 further comprising surface functionalizing the portion of the nanostructures that are exposed.

16. The method of claim 9, wherein the deposition of the second material extends beyond filling the unfilled portion of the pores to form a desired shape on a tip of the nanostructures.

17. The method of claim 16, wherein the nanostructures are shaped to be branched antennas, pyramidal, cigar shaped, modulated diameters, hexagonal, rectangular, conical, or disc shaped.

18. The method of claim 9, wherein at least a portion of the nanostructure is porous.

19. An exposed segmented nanostructure array comprising:
a conductive layer;
a nonconductive layer on top of the conductive layer; and
a plurality of segmented nanostructures, wherein a bottom portion of the nanostructures are embedded in the nonconductive layer, and a top portion of the nanostructures are exposed.

20. The array of claim 19, wherein the nanostructures are shaped to be branched antennas, pyramidal, cigar shaped, modulated diameters, hexagonal, rectangular, conical, or disc shaped.

21. The array of claim 19, wherein the top portion of the nanostructure is covered by a shell of a different material than the nanostructure.

22. The array of claim 19, wherein the nanostructure comprises a first region formed from a first material and a second region formed from a second material.

23. The array of claim 22, wherein the top portion of the nanostructure is covered by a shell comprising a third material.

24. The array of claim 22, wherein the first material is conductive and the second material is nonconductive.

25. The array of claim 22, wherein the nanostructures are shaped to be branched antennas, pyramidal, cigar shaped, modulated diameters, hexagonal, rectangular, conical, or disc shaped.

26. The array of claim 25, wherein the top portion of the nanostructure is covered by a shell comprising a third material.
